(19) United States
(12) Patent Application Publication
(10) Pub. No.: US 2013/0244852 A1
(43) Pub. Date: Sep. 19, 2013

(54) METHOD AND DEVICE FOR PRODUCING COFFEE FILTERS

(71) Applicants: Walter Hilger, Kottenheim (DE); Bernd Gobel, Gamlen (DE); Hartmut Stoye, Mayen (DE)

(72) Inventors: Walter Hilger, Kottenheim (DE); Bernd Gobel, Gamlen (DE); Hartmut Stoye, Mayen (DE)

(73) Assignee: BIKOMA GMBH SPEZIALMASCHINEN, Mayen (DE)

(21) Appl. No.: 13/421,231

(22) Filed: Mar. 15, 2012

(51) Int. Cl. B31B 1/14

(52) U.S. Cl. 493/340

(57) ABSTRACT

A method for a continuous production of filters, particularly coffee filters and the like, from a material web, including the steps of (a) cutting parallel in reference to the direction of transportation of the material web to separate at least two rows of filter contours extending parallel in reference to the direction of transportation of the material web into one partial material web each, and (b) separating the filters of the respective partial material webs. The cutting to separate at least two rows into one partial material web each occurs essentially based on a cut with a wave-like progression. At least two partial material webs are arranged over top of each other such that a separation of the filters of the respective partial material webs occurs by a joint cut. A device for a continuous production of filters is also provided.

### FIELD OF THE INVENTION

The invention relates to a method for a continuous production of filters, particularly coffee filters and the like, from a material web comprising the steps: cutting parallel in reference to the direction of transportation of the material web for separating at least two rows of filter contours extending parallel in reference to the direction of transportation of the material web into one partial material web each and separating the filters of the respective material webs.

The invention relates to another method for the continuous production of filters, particularly coffee filters and the like, from a material web.

The invention also relates to a device for the continuous production of filters, particularly coffee filters and the like, from a material web and particularly suitable for performing the method, comprising means for separating at least two rows of filter contours extending parallel in reference to the direction of transportation of the material web into one partial material web each and means for separating the filters of the partial material webs.

The invention finally relates to another device for the continuous production of filters, particularly coffee filters and the like, from a material web, particularly suitable for the performance of the method according to the invention.

### BACKGROUND

In prior art it is already known to first cut opening aids into the respective contours of the filters in a continuously traveling material web into two rows of unfolded contours of filters to be cut, extending parallel in the direction of transportation, and for the filters later to be cut. Here, the material web is essentially separated simultaneously into two identically sized partial material webs by a continuous straight cut along the center of the material web parallel in reference to the direction of transportation. The two partial material webs are then commonly guided over a folding triangle so that the contours of the filters are folded together. Subsequently they are connected to each other along their folded together contour by way of embossed seams. After the connection, the filters are then separated in a final step by way of being cut out along their folded together contour.

The material web is here wider than the maximum width of the filters later produced therefrom so that here several filters can be produced from the material web next to each other (i.e. perpendicular in reference to the direction of transportation).

Here it is disadvantageous that by the above-mentioned cutting of the filter contours discards are produced, which represent a considerable amount of the material to be used for the production of the filters. Furthermore, cutting tools are required for each material web and/or partial material web for the opening aids, for the separation of the material web, and for the separation of the filters from the partial material webs. Accordingly, the production costs for the filters are high.

### SUMMARY

The objective of the present invention is therefore to provide a method and a device which reduce the required material use and the costs for the production of the filters without aggravating the production process overall.

The objective is here attained in a method according to the invention in that the cutting to separate at least two rows into one partial material web each essentially occurs by a cut exhibiting a wave-like progression. Due to the cutting occurring with a wave-like cut it is possible to later separate the filters to be cut at least partially directly along their unfolded contour from the rest of the material and/or partial material web. The sections of the material web saved here compared to the straight separating cut of prior art can then be used to arrange other outer contours of other objects and to cut them so that more objects can be produced from the same width of the material web. Accordingly the overall production costs drop.

The objective is also attained in a method according to the invention in that at least two partial material webs are arranged over top of each other such that the separation of the filters of the partial material web occurs by a joint cut. After the separation of the material web the two partial material webs are guided according to the invention over top of each other, i.e. in two planes parallel in reference to each other. After compensating any potential off-sets of the partial material webs and/or the filters to be cut along their respective contours in reference to each other the filters are simultaneously cut from the partial material webs by a common cutting tool and separated here. This way, a separate cutting tool is not required for the second material web in order to separate the filters. The production costs for the filters are considerably reduced this way.

Beneficially the method comprises the cutting of an opening aid into the contour of at least one filter of each row, with particularly the cutting of the opening aid occurring mirror-symmetrically in reference to the central axis of the material web. When an opening aid is cut, the filter can then easier be opened for use e.g., in a coffee maker. When the opening aid is cut mirror-symmetrically in reference to the central axis of the material web it is here avoided that the two partial material webs additionally must be rotated by 180 degrees in order for the filters of the respective material webs to be cut directly lying over top of each other with their respective contour and this way can be separated in a single step.

Beneficially the wave-like cutting progresses occur during the transportation of the material web alternating essentially partially parallel in reference to the contour of a filter of one row and partially parallel in reference to the contour of a filter of the other row. By the wave-like progression of the cut, this way first a part of a contour of a filter is cut out separate from the rest of the material web under a minimum of material use, subsequently a portion of the adjacent contour of a filter is again separated from the rest of the material web. This way, the section not impinged by the cut is further optimized and/or enlarged such that even larger objects can be arranged in this area, cut out later, and separated. This lowers both the material consumption as well as the production costs for the filters and/or the objects.

Beneficially the cutting of the opening aid and the separation of at least two rows into respective partial material webs occurs jointly by a cut with a wave- like progression. For filters with opening aids usually first an opening aid for the filter must be cut into the contour of the filter. When the cutting of the opening aid and the separation of at least two rows into respective partial material webs occurs jointly by the wave-like cut here an otherwise required separate expensive cutting tool can be waived, which allows considerable cost advantages for the production of the filter.

Advantageously the cutting of the opening aids occurs in the respective rows parallel in reference to the direction of transportation and off-set to each other. This way it is possible to arrange the opening aids for the filter of the neighboring row of contours of filters to be cut in the section respectively excluded by the wave-like cut of the first row of filters. Overall, this way the material consumption for the production of filters is further reduced.

In order to further increase the material savings it is beneficial that the cutting for separating at least two rows occurs such that the sum of maximum widths of partial material webs is greater than the width of the material web. The wave-like cutting edge then extends at a sufficiently wide, but as small as possible distance along the contour of one filter and then directly transfers into a progression along the contour of the other filter so that overall the cutting occurs partially “around” the filter in the direction of transportation of the material web. The material savings for the material web then results from the overlap of the respective maximum width of the partial material web, i.e. in order to cut the same number of filters overall a material web of smaller width can be used.

A device for the continuous production of filters, particular coffee filters and the like, from a material web, particularly suitable to perform the method according to the invention comprises means to separate at least two rows of filter contours extending parallel in reference to the direction of transportation of the material web into one partial material web each and means to separate the filters of the partial material webs. The device attains the objective according to the invention such that the means for separating at least two rows of filter contours comprise means to create a wave-like cut. By the wave-like cutting edge it is possible to provide larger uncut sections of the material web so that these sections can be used for additional contours of objects to be cut; overall hereby the utilization is optimized of the material web with regards to the area available.

Another device for a continuous production of filters, particularly coffee filters and the like, from a material web according to the invention is particularly suitable to perform the method according to the invention and attains the objective according to the invention such that means to separate the filters of the respective partial material web comprise a cutting tool, particularly a knife, for the simultaneous separation of the filters of both partial material webs. By the arrangement of only one cutting tool to jointly separate the filters of both partial material webs an additional cutting tool for the second partial material web can be omitted; the production costs of the filters are thereby considerably reduced.

Advantageously, the means for creating a wave-like cut comprise a cutting tool, which cuts at least partially essentially parallel in reference to the contour of a filter of one row of filters and/or partially essentially parallel in reference to the contour of the second filter of the second row of filters. This way, the sections of the material web which are additionally used for further contours of objects to be cut out can be further increased and/or optimized.

Beneficially, the means for separation comprise means for cutting opening aids for at least one filter of one partial material web, particularly for at least one filter each of both partial material webs. This way, it is possible in a single cut to cut both an opening aid for at least one filter but also to cut the material web into at least two partial material webs. Accordingly, separately required cutting tools for the opening aids of both rows can therefore be omitted, which provides considerable cost benefits.

In order to achieve a more consistent load of the material web and simultaneously further reducing the material consumption it is beneficial for the means for cutting the opening aids to be arranged such that the cutting of the opening aids of the respective rows each occur parallel off-set in the direction of transportation of the material web.

### BRIEF DESCRIPTION OF THE DRAWINGS

Additional features and advantages of the invention result from the following description of an exemplary embodiment using on the drawings. Shown are:

FIG. 1 is a view of a material web with filter contours to be cut according to prior art,

FIG. 2 is a view of a material web with filter contours to be cut with said cut showing a wave-like progression according to the invention,

FIG. 3 is a top plan view of a coffee filter forming device in accordance with a preferred embodiment of the invention,

FIG. 4 is a side elevational view of the coffee filter forming device taken along line 4-4 in FIG. 3, and

FIG. 5 is a side elevational view of the coffee filter forming device taken along line 5-5 in FIG. 3.

### DETAILED DESCRIPTION OF THE PREFERRED EMBODIMENT

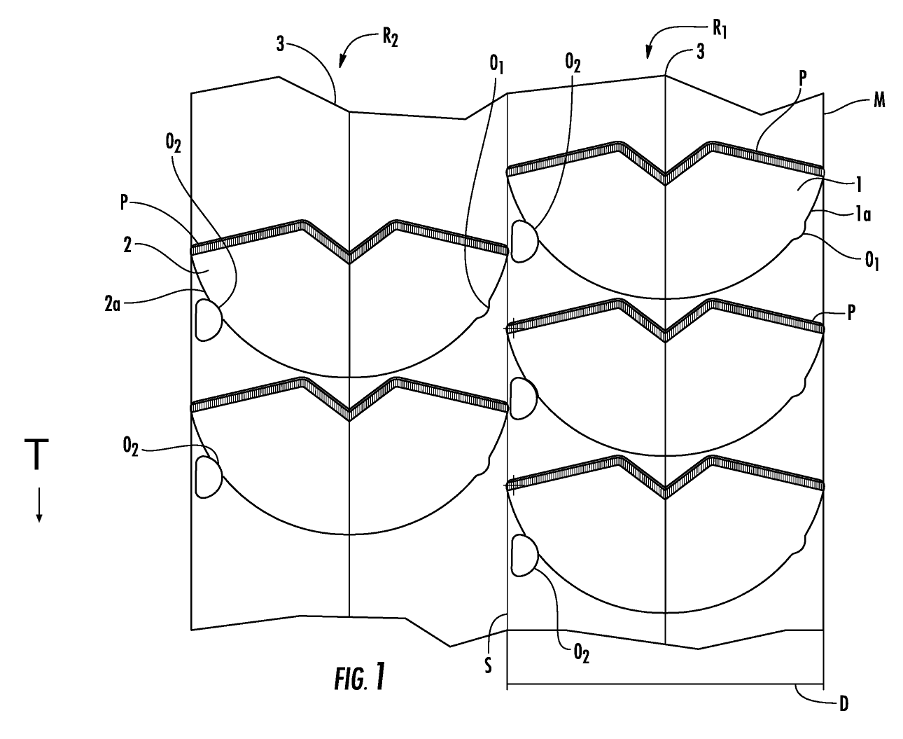

FIG. 1 shows a detail of a conventionally traveling material web M with two rows R₁, R₂ of contours 1a, 2a of coffee filters 1, 2 to be cut extending parallel in reference to the direction of transportation T. Here, the contours 1a, 2a show the form of an unfolded coffee filter 1, 2. Here, the contours 2a of the coffee filters 2 of the row R₂ to be cut are arranged offset and parallel in reference to the direction of transportation T compared to the contours la of the coffee filters 1 of the row R₁.

The contour 1a, 2a of the coffee filters 1, 2 comprises in its respectively right area (according to FIG. 1), beginning from its folding axis 3, a bulge O₁ outward in the radial direction. On the respectively opposite side, symmetrical in reference to the folding axis 3, however a radial indentation O₂ is arranged, which via a separate cutting tool is cut into the unfolded contour 1a, 2a of the coffee filters 1, 2 prior to the folding and separating of the coffee filters 1, 2. When now the coffee filters 1, 2 are folded together for their production about their symmetry and/or folding axis 3 after the two rows R₁, R₂ have been separated into two partial material webs R₁, R₂ via a straight cut S, here overall an opening aid O₁, O₂ results for the coffee filter 1, 2.

The width D of the rows R₁, R₂ and/or after the separation of the rows of the partial material webs R₁, R₂ is here essentially equivalent to the maximum width of the contour 1a, 2a of the coffee filters 1, 2. After folding together the coffee filters 1, 2 they are partially connected along their contours and/or edges lying on top of each other by an embossed seam P and separated from their respective partial material webs R₁, R₂ via the respective cutting tools.

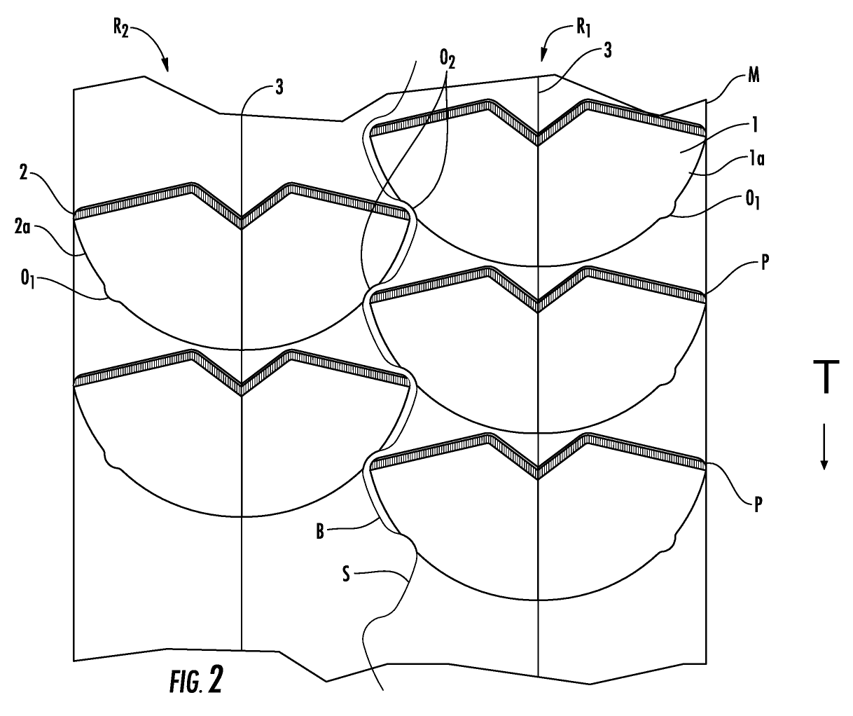

FIG. 2 shows a detail of a continuously traveling material web M with a cutting pattern according to the method of the invention and/or created via a device according to the invention. Similar to FIG. 1, contours 1a, 2a of unfolded coffee filters 1, 2 are arranged in two rows R₁, R₂ extending parallel in reference to the direction of transportation T. The coffee filters 1, 2 essentially comprise a semi-secular shape, with the essentially curved area respectively being oriented in the direction of transportation T. Different from FIG. 1, the opening aids O₂ are cut axially symmetrical (axially parallel in reference to the direction of transportation T) so that the bulge O₁ of the contour 1a of the coffee filters 1 of the row R₁ points towards the exterior right edge of the material web M, while the bulge O₁ of the contours 2a of the coffee filters 2 of the row R₂ is oriented in the direction towards the left exterior edge of the material web M. The indentations O₂ of the opening aids are oriented in the direction of the interior of the material web M, i.e. towards the center of the material web M, and are cut by the cut S with a wave-like progression into the contour 1a, 2a of the coffee filters 1, 2. Simultaneously the cut S also separates the material web M into the two partial material webs R₁, R₂.

The contours 1a, 2a of the coffee filters 1, 2 of the rows R1, R2 are arranged on the material web M off-set in the horizontal direction T essentially by half of the extension of the contour 1a, 2a of the coffee filters 1, 2 parallel in reference to the direction of transportation T. Furthermore, the coffee filters 1, 2 are arranged such that the unfolded contour 2a of the coffee filters 2 at least partially projects into the intermediate section of two unfolded contours la of coffee filters 1 of the row R₁ following each other in the direction of transportation T.

The cutting edge of the wave-like cut S extends essentially along the middle of the material web M in the direction of transportation. This progression of the cut S to separate the material web M and to cut the opening aid O₂ is discernible from FIG. 2 In FIG. 2 the cut S follows from the bottom towards the top (here starting at the point B) in a predetermined distance as small as possible essentially parallel in reference to and left from the unfolded contour 1a of a coffee filter 1 to be cut and then turns to the unfolded contour 2a of a coffee filter 2 of the row R₂, cutting an indentation O₂ into the unfolded contour 2a of the coffee filter 2, progresses then further essentially parallel at the right with a predetermined small distance from the unfolded contour 2a of the coffee filter 2 of the row R₂ along to the unfolded contour 1a of a subsequent coffee filter 1a of the row R₁, cutting into it an indentation O₂ and then further progresses essentially parallel at the left and with a small predetermined distance from the unfolded contour la of the coffee filter 1 and then further meets the unfolded contour 2a of a coffee filter 2 arranged diagonally above the coffee filter 1 and cuts an indentation O₂ into the unfolded contour 2a of the coffee filter 2 and so on. The cutting edge of the cut S therefore progresses essentially wave-like along the direction of transportation T in the middle of the material web M and the cut S cuts each alternating indentations O₂ for operating aids into the unfolded contours 1a of one row R₁ of coffee filters 1 and into the unfolded contours 2a of the other row R₂ of coffee filters 2 and simultaneously separates the material web M into two partial material webs R₁, R₂.

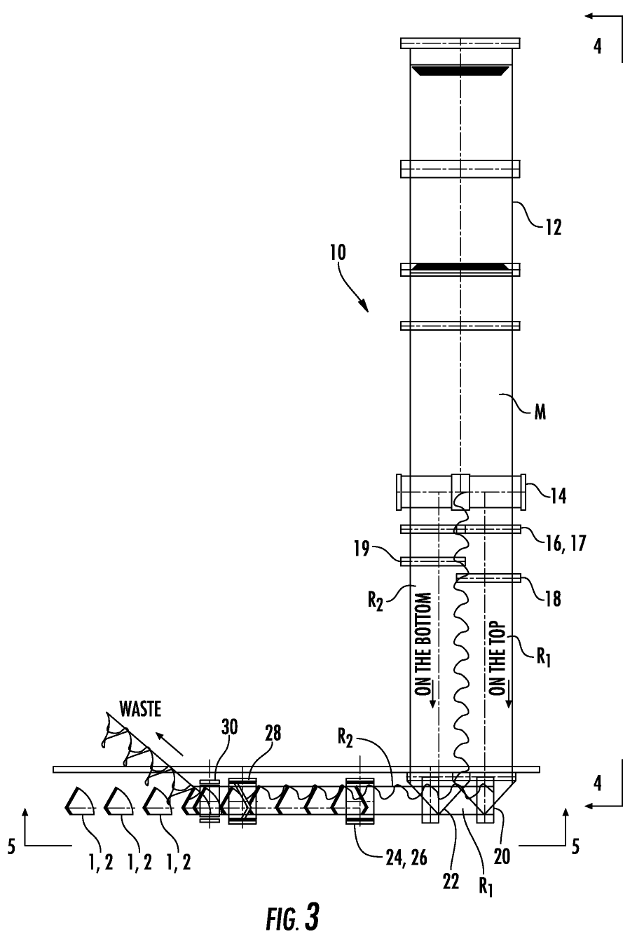

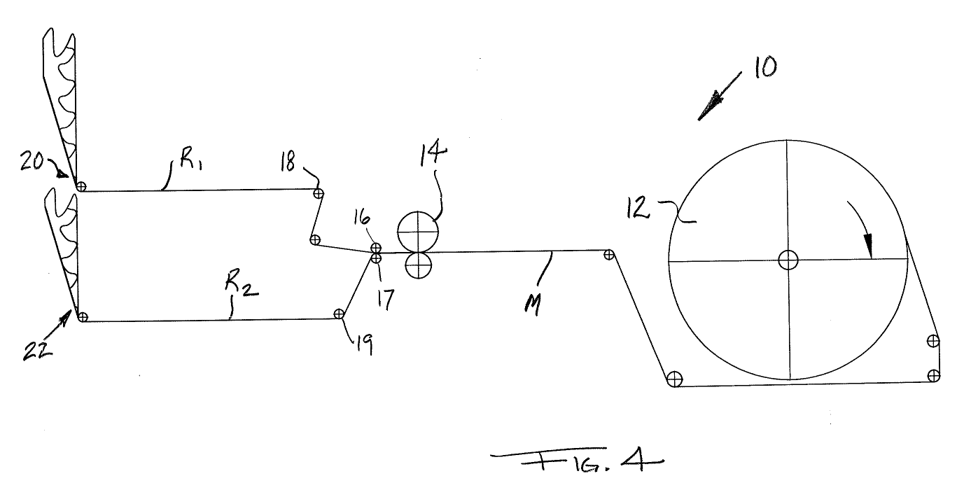

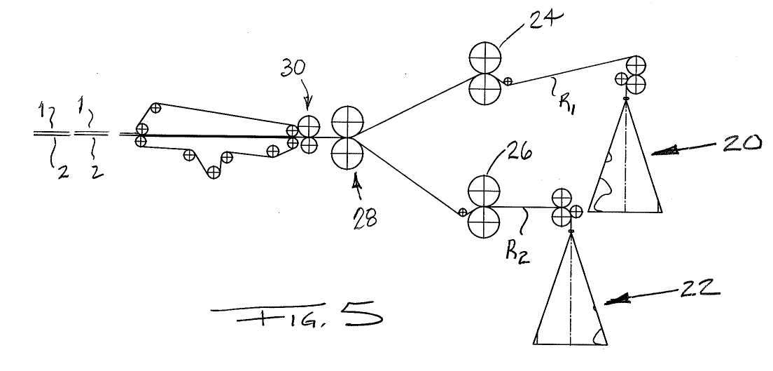

Referring to FIGS. 3-5, the coffee filter forming device 10 and the method according to the invention are described in detail, as follows: First the material web M provided from an unwind station 12 is separated by the wave-like cut S according to the invention using cutting rolls 14 into two partial material webs R₁, R₂. Simultaneously, the wave-like cut S progresses partially in the area of the unfolded contour 1a, 2a of coffee filters 1, 2 to be cut and alternating cuts indentations O₂ for the opening aid for the coffee filters 1, 2 of one and the other row R₁, R₂ into the material web M/partial material webs R₁, R₂. This way, one cutting tool can be omitted.

After the division of the material web M the partial material webs R₁, R₂ are preferably vertically separated by rollers 16, 17, 18, 19 into different parallel planes, and are then each folded about their folding and/or symmetrical axis 3 for example via folding triangles 20, 22. Then, partially the edges of the contour 1a, 2a of the respective coffee filters 1, 2 lying on top of each other are connected to each other via an embossed seam P formed by pairs of crimping rollers 24, 26. Subsequently the partial material webs R₁, R₂ are guided over top of each other, preferably via infeed rollers 28, such that the contours 1a, 2a of the filters 1, 2 to be cut, which are folded together and partially embossed, are each positioned directly over top of each other. The two partial material webs R₁, R₂ are then further guided through a cutting tool 30, preferably cutting rolls, which then cuts the respective contours 1a, 2a of the coffee filters 1, 2 on the respective partial material webs R1, R2 by a single cut and this way the coffee filters 1, 2 of the partial material webs R₁, R₂ are simultaneously separated, and discharged in stacked pairs.

Summarizing, the invention shows several advantages. By the invention material savings are possible during the production of filters, particularly coffee filters. Furthermore, the production costs are reduced because the number of cutting tools for the production of coffee filters can be reduced.

1. A method for the continuous production of filters from a material web (M), comprising the steps of
a. cutting parallel in reference to the direction of transportation (T) of the material web (M) to separate at least two rows (R₁, R₂) of filter contours (1a, 2a) extending parallel in reference to the direction of transportation (T) of the material web (M) into one partial material web each, and
b. separating the filters of the respective partial material webs, wherein the cutting to separate the at least two rows (R₁, R₂) into the partial material webs is carried out essentially based on a cut (S) with a wave-like progression.

2. The method for the continuous production of filters from a material web according to claim 1, wherein the at least two partial material webs are arranged over top of each other such that the separation of the filters (1, 2) of the respective partial material webs (R₁, R₂) occurs by a joint cut (S).

3. The method according to claim 1, further comprising cutting an opening aid (O₂) into the contour (1a, 2a) of at least one filter (1, 2) of each of the rows (R₁, R₂), with the cutting of the opening aid (O₂) occurring mirror symmetrical in reference to a central axis of the material web (M).

4. The method according to claim 1, wherein the wave-like cut (S) progresses alternating essentially partially parallel in reference to the contour (1a, 2a) of a filter (1, 2) of one row (R₁, R₂) and partially parallel in reference to the contour (1a, 2a) of a filter (1, 2) of the other row (R₁, R₂) of the filter (1, 2).

5. The method according to claim 3, wherein the cutting of the opening aids (O₂) and the separation of at least two rows (R₁, R₂) into respective partial material webs (R₁, R₂) occurs jointly by the cut (S) having the wave-like progression.

6. The method according to claim 5, wherein the cutting of the opening aids (O₂) of the respective rows (R₁, R₂) occurs parallel in reference to the direction of transportation (T) of the material web (M) off-set in reference to each other.

7. The method according to claim 1, wherein the cutting to separate at least two rows (R₁, R₂) occurs such that a sum of a maximum width of the partial material webs is greater than a width of the material web (M).

8. The method of claim 1, wherein the filter is a coffee filter.

9. A device (10)for a continuous production of filters (1, 2) from a material web (M), comprising
a. means for separating at least two rows (R₁, R₂) of filter contours (1, 2) extending parallel in reference to a direction of transportation of the material web (M) into one partial material web each, and
b. means to separate the filters of the partial material webs (R₁, R₂), wherein the means for separating at least two rows (R₁, R₂) of filter contours (1a, 2a) comprise means to create a wave-like cut (S).

10. The device for the continuous production of filters (1, 2) from a material web (M) according to claim 9, wherein the means to separate the filters (1, 2) of the respective partial material webs (R₁, R₂) comprise cutting tools for a simultaneous separation of the filters (1, 2) of the two partial material webs (R₁, R₂).

11. The device according to claim 9, wherein the means to create the wave-like cut (S) comprises a cutting tool, which at least partially cuts at least one of parallel in reference to the contour (1a, 2a) of a filter (1, 2) of one of the rows (R₁, R₂) of filters (1, 2) or partially essentially parallel in reference to the contour (1a, 2a) of the second filter (1, 2) of the second row (R₁, R₂) of filters (1, 2).

12. The device according to claim 9, wherein the means for separation comprise means for cutting opening aids (O₂) for at least one filter (1, 2) of one of the partial material webs.

13. The device according to claim 9, wherein the means for cutting the opening aids (O₂) are arranged such that the cutting of the opening aids (O₂) of the respective rows (R₁, R₂) occurs respectively off-set parallel in the direction of transportation (T) of the material web.
